(19) United States
(12) Patent Application Publication
(10) Pub. No.: US 2005/0197133 A1
(43) Pub. Date: Sep. 8, 2005

(54) System and method for changing frequency assignment in a broadband wireless access communication system

(75) Inventors: Seung-Eun Hong, Suwon-si (KR); Bong-Gee Song, Seongnam-si (KR); Kwang-Seop Eom, Seongnam-si (KR); Hyon-Goo Kang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/072,936

(22) Filed: Mar. 4, 2005

(30) Foreign Application Priority Data
Mar. 5, 2004 (KR) 10-2004-0015206

(51) Int. Cl. H04Q 7/20

(52) U.S. Cl. 455/450; 455/447

(57) ABSTRACT

In a Broadband Wireless Access (BWA) communication system having at least two FAs, a base station (BS) requests a subscriber station (SS) to change its FA from the first FA to the second FA, upon detecting a need to change an FA of the SS from the first FA to the second FA while communicating with the SS. The SS informs the BS that it will change its FA from the first FA to the second FA in response to the FA change request, and then changes its FA from the first FA to the second FA. After changing the FA, the SS communicates with the BS through the second FA.

### PRIORITY

This application claims priority under 35 U.S.C. § 119 to an application entitled “System and Method for Changing Frequency Assignment in a Broadband Wireless Access Communication System” filed in the Korean Intellectual Property Office on Mar. 5, 2004 and assigned Ser. No. 2004-15206, the contents of which are incorporated herein by reference.

### BACKGROUND OF THE INVENTION

1. Field of the Invention

The present invention relates generally to a Broadband Wireless Access (BWA) communication system, and in particular, to a system and method for changing a Frequency Assignment (FA).

2. Description of the Related Art

In a communication system based on the Institute of Electrical and Electronics Engineers (IEEE) 802.16d standard, which is a BWA communication system, a base station (BS) managing a plurality of Frequency Assignments (FAs) assigned thereto transmits a De/Re-register Command (DREG_CMD) message to a subscriber station (SS) when the BS determines that the SS communicating through a particular FA is to transition to a different FA, i.e., when a change from a current FA used by the SS to another FA is required. However, in the IEEE 802.16d communication system, the BS does not separately identify an FA to which the SS should transition to, in the DREG_CMD message. Although the SS is informed that it should change its current FA to a different FA as it receives the DREG_CMD message from the BS, it is not sent information identifying a target FA to which it should change its FA. Therefore, the SS selects a particular FA from among FAs in an FA list, assigned to the BS, and performs a network re-entry operation using the selected FA.

With reference to FIG. 1, a description will now be made a process of changing an FA in an IEEE 802.16d communication system.

FIG. 1 is a signaling diagram illustrating a process of changing an FA in a general IEEE 802.16d communication system. It will be assumed in FIG. 1 that a BS of the IEEE 802.16d communication system provides 3 FAs of FA#1, FA#2 and FA#3, and an SS is communicating with the BS through FA#1.

Referring to FIG. 1, while communicating with the SS through the FA#1 (Step 111), the BS can change an FA of the SS from FA#1 to an FA different from FA#1, i.e., FA#2 or FA#3, for load sharing of FA#1. For that purpose, the BS commands the SS to change its FA from FA#1 to another FA by transmitting a DREG_CMD message to the SS (Step 113).

The SS receiving the DREG_CMD message from the BS performs an FA selection operation with FA#2 and FA#3 as is done in a general cell selection process (Steps 115 and 117). Here, the “FA selection operation” refers to transmitting a Ranging Request (RNG_REQ) message through a corresponding FA and receiving a Ranging Response (RNG_RSP) message in response to the RNG_REQ message through the corresponding FA. Thereafter, the SS analyzes the RNG_RSP messages received from the FA#2 and FA#3, and selects an FA providing a higher channel quality from FA#2 and FA#3 based on the analysis result. It is assumed in FIG. 1 that the SS selects FA#3 as a new FA.

After selecting FA#3 as a new FA, the SS performs a network re-entry operation with the BS through FA#3 (Step 119). Here, the “network re-entry operation” refers to acquiring synchronization with the BS through a new FA as the SS changes its current FA to the new FA, and performing initial ranging, authentication and registration operations also through the new FA. As a result, the IEEE 802.16d communication system changes an FA of an SS through a de/re-registration process.

With reference to FIG. 1, a description has been made of a process of changing an FA in a general IEEE 802.16d communication system. Next, with reference to FIG. 2, the changing an FA in a general IEEE 802.16e communication system will be described.

FIG. 2 is a signaling diagram illustrating a process of changing an FA in a general IEEE 802.16e communication system. It will be assumed in FIG. 2 that a BS of the IEEE 802.16e communication system provides 3 FAs of FA#1, FA#2 and FA#3, and a mobile subscriber station (MSS) is communicating with the BS through FA#1. In the IEEE 802.16e communication system where mobility of an SS is taken into consideration, the SS is called an MSS.

Referring to FIG. 2, while communicating with the MSS through FA#1 (Step 211), the BS can change an FA of the MSS from FA#1 to an FA different from FA#1, i.e., FA#2 or FA#3, for load sharing of FA#1. The BS transmits a Base Station initiated HandOver Request (BSHO_REQ) message to the MSS (Step 213). Here, the BS's transmitting the BSHO_REQ message to the MSS implies that the MSS should change its FA from FA#1 to FA#2 or FA#3.

The MSS receiving the BSHO_REQ message transmits a Scanning Request (SCN_REQ) message to the BS through FA#1 in order to scan FA#2 or FA#3 (Step 215). Here, the SCN_REQ message includes information identifying a scanning interval during which the MSS is to perform scanning for measurement of a carrier-to-interference and noise ratio (CINR) of a pilot signal transmitted through FA#2 or FA#3, and information identifying a time when it will start the scanning operation. The BS receiving the SCN_REQ message from the MSS transmits a Scanning Response (SCN_RSP) message to the MSS in response to the SCN_REQ message through FA#1 (Step 217). Here, the SCN_RSP message includes information identifying the scanning interval and an expected scanning start time.

The MSS receiving the SCN_RSP message scans CINRs of pilot signals received through FA#2 and FA#3 according to the SCN_RSP message (Step 219). The MSS transmits a HandOver Response by MSS (MSSHO_RSP) message to the BS in response to the BSHO_REQ message through FA#1 according to the pilot signals' CINR scanning results (Step 221). Here, the MSSHO_RSP message includes the scanning results of FA#2 and FA#3.

The BS receiving the MSSHO_RSP message from the MSS transmits a HandOver Response by BS (BSHO_RSP) message commanding the SS to perform handover from FA#1 to FA#3, to the MSS through FA#1 according to the scanning results (Step 223). Here, the BSHO_RSP message includes information indicating that the MSS should change its FA from FA#1 to FA#3. The MSS receiving the BSHO_RSP message transmits a Handover Indication (HO_IND) message informing that the MSS will change its FA from FA#1 to FA#3, to the BS through FA#1 (Step 225).

After transmitting the HO_IND message to the BS, the MSS deregisters a connection to FA#1 and performs a network re-entry operation with the BS through FA#3 (Step 227). As a result, the IEEE 802.16e communication system changes an FA of an SS through a handover process.

### SUMMARY OF THE INVENTION

The foregoing FA change schemes, i.e., the FA change scheme described with reference to FIG. 1 and the FA change scheme described with reference to FIG. 2, have the following problems.

In the scheme of changing an FA using a DREG_CMD message described with reference to FIG. 1, i.e., in the FA change scheme based on the de/re-registration operation, because an SS needs to select a new FA and perform a network re-entry operation with a BS through the selected FA, a service delay is caused by the FA selection and network re-entry operations. In this case, the service delay causes a deterioration in the quality-of-service (QoS) or reduces a service flow itself. In addition, the BS cannot change an FA of the SS to its desired FA, causing a reduction in the efficiency of the BS load sharing.

The scheme of changing an FA through a handover operation, described with reference to FIG. 2, requires exchanging a plurality of messages between a BS and an MSS, and the MSS must perform a network re-entry operation with the BS through a new FA, causing a service delay due to the message exchange and network re-entry operations. The service delay causes a reduction in the QoS.

It is, therefore, an object of the present invention to provide an FA change system and method for minimizing a service delay in a Broadband Wireless Access (BWA) communication system.

It is another object of the present invention to provide a system and method for changing an FA without a network re-entry operation in a BWA communication system.

In accordance with a first aspect of the present invention, there is provided a system for changing a Frequency Assignment (FA) to allow a subscriber station (SS) communicating with a base station (BS) through a first FA to communicate with the BS through a second FA, in a Broadband Wireless Access (BWA) communication system having at least two FAs. The system includes a BS for requesting a SS to change its FA from the first FA to the second FA upon detecting a need to change an FA of the SS from the first FA to the second FA while communicating with the SS, and communicating with the SS through the second FA upon receiving information indicating that the SS will change its FA from the first FA to the second FA, from the SS in response to the FA change request; and the SS for informing the BS that it will change its FA from the first FA to the second FA in response to the FA change request, thereafter, changing its FA from the first FA to the second FA, and communicating with the BS through the second FA.

In accordance with a second aspect of the present invention, there is provided a system for changing a service through a second Frequency Assignment (FA) by a subscriber station (SS) communicating with a base station (BS) through a first FA, in a Broadband Wireless Access (BWA) communication system having at least two FAs. The system includes a SS for requesting a BS to change the service upon detecting a need to change the service while communicating with the BS through the first FA, informing the BS that it will change its FA from the first FA to the second FA in response to an FA change request and then changing its FA from the first FA to the second FA when it is requested by the BS to change its FA from the first FA to the second FA if the BS cannot change the service, and then performing service change with the BS through the second FA; and the BS for, upon detecting the service change request, determining if it can change the service through the first FA, if it is determined that it cannot change the service, requesting the SS to change its FA from the first FA to the second FA, and then, upon receiving, from the SS, information indicating that it will change its FA from the first FA to the second FA in response to the FA change request, performing service change with the SS through the second FA.

In accordance with a third aspect of the present invention, there is provided a method for changing a Frequency Assignment (FA) to allow a subscriber station (SS) communicating with a base station (BS) through a first FA to communicate with the BS through a second FA, in a Broadband Wireless Access (BWA) communication system having at least two FAs. The method includes the steps of requesting, by the BS, the SS to change its FA from the first FA to the second FA, upon detecting a need to change an FA of the SS from the first FA to the second FA while communicating with the SS; informing, by the SS, the BS that it will change its FA from the first FA to the second FA in response to the FA change request, and then changing its FA from the first FA to the second FA; and after changing the FA, communicating by the SS with the BS through the second FA.

In accordance with a fourth aspect of the present invention, there is provided a method for changing a service through a second Frequency Assignment (FA) by a subscriber station (SS) communicating with a base station (BS) through a first FA, in a Broadband Wireless Access (BWA) communication system having at least two FAs. The method includes the steps of requesting, by the SS, the BS to change the service, upon detecting a need to change the service while communicating with the BS through the first FA; upon detecting the service change request, determining by the BS if it can change the service through the first FA; if it is determined that it is not possible to change the service, requesting, by the BS, the SS to change its FA from the first FA to the second FA; informing, by the SS, the BS that it will change its FA from the first FA to the second FA in response to the FA change request, and then changing its FA from the first FA to the second FA; and after changing the FA, performing, by the SS, a service change with the BS through the second FA.

In accordance with a fifth aspect of the present invention, there is provided a method for communicating with a base station (BS) by a subscriber station (SS) when the SS communicating with the BS through a first Frequency Assignment (FA) changes its FA to a second FA, in a Broadband Wireless Access (BWA) communication system having at least two FAs. The method includes the steps of, after changing the FA, receiving an assigned fast ranging resource from the BS through the second FA so that the SS can perform contention-free-based initial ranging; sending an initial ranging request to the BS through the second FA using the assigned fast ranging resource; receiving a response to the initial ranging request from the BS; and after receiving the response to the initial ranging request, communicating with the BS through the second FA.

In accordance with a sixth aspect of the present invention, there is provided a method for communicating with a base station (BS) by a subscriber station (SS) when the SS communicating with the BS through a first Frequency Assignment (FA) changes its FA to a second FA, in a Broadband Wireless Access (BWA) communication system having at least two FAs. The method includes the steps of, after changing the FA, receiving an assigned fast ranging resource from the BS through the second FA so that the SS can perform contention-free-based initial ranging; sending an initial ranging request to the BS through the second FA using the assigned fast ranging resource; receiving a response to the initial ranging request from the BS; after receiving the response to the initial ranging request, sending a service change request to the BS through the second FA upon detecting a need to change a service; upon receiving service change possibility information from the BS in response to the service change request, informing the BS of an acknowledgement of the service change possibility information; and performing the changed service with the BS.

### BRIEF DESCRIPTION OF THE DRAWINGS

The above and other objects, features and advantages of the present invention will become more apparent from the following detailed description when taken in conjunction with the accompanying drawings in which:

FIG. 1 is a signaling diagram illustrating a process of changing an FA in a general IEEE 802.16d communication system;

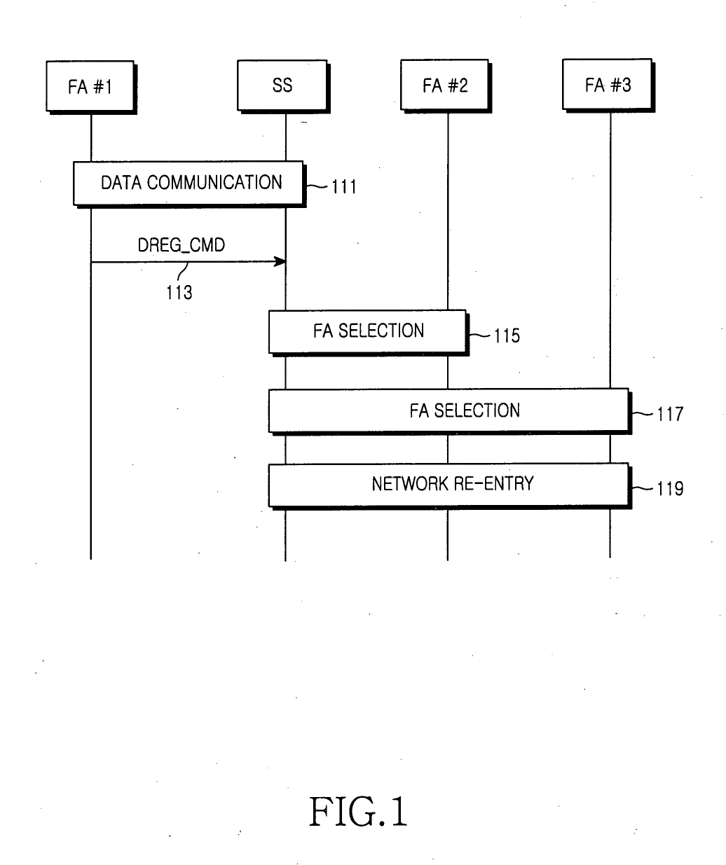

FIG. 2 is a signaling diagram illustrating a process of changing an FA in a general IEEE 802.16e communication system;

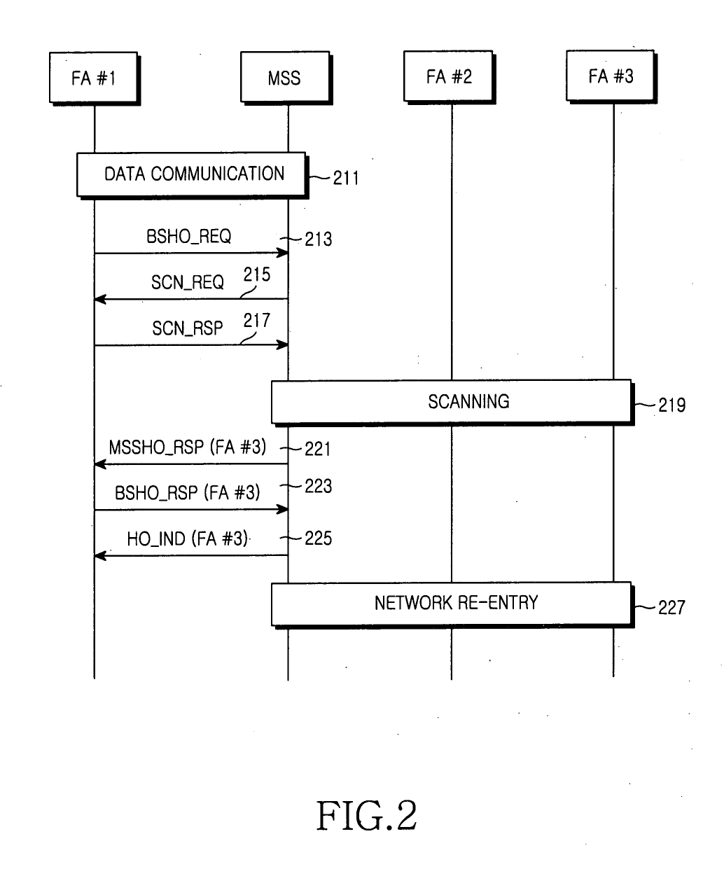

FIG. 3 is a signaling diagram illustrating a process of changing an FA in an IEEE 802.16e communication system according to an embodiment of the present invention;

FIG. 4 is a signaling diagram illustrating a process of changing a service using an FA change scheme in an IEEE 802.16e communication system according to an embodiment of the present invention;

FIG. 5 is a flowchart illustrating a BS operation of changing a service using an FA change scheme in an IEEE 802.16e communication system according to an embodiment of the present invention; and

FIG. 6 is a flowchart illustrating an MSS operation of changing a service using an FA change scheme in an IEEE 802.16e communication system according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

The present invention proposes a scheme for dynamically changing a Frequency Assignment (FA) in a communication system based on the Institute of Electrical and Electronics Engineers (IEEE) 802.16e standard, which is a BWA communication system. That is, the present invention proposes a dynamic FA change scheme that can minimize a service delay and does not require a network re-entry operation when a base station (BS) needs to change an FA for load sharing during communication. The IEEE 802.16e communication system, a BWA communication system using an Orthogonal Frequency Division Multiplexing (OFDM) scheme and an Orthogonal Frequency Division Multiple Access (OFDMA) scheme, can enable a high-speed data transmission by transmitting physical channel signals, and supports a multicell structure to support the mobility of a mobile subscriber station (MSS). Although the present invention will be described with reference to the IEEE 802.16e communication system, the present invention can be applied not only to the IEEE 802.16e communication system but also to other communication systems providing a plurality of FAs.

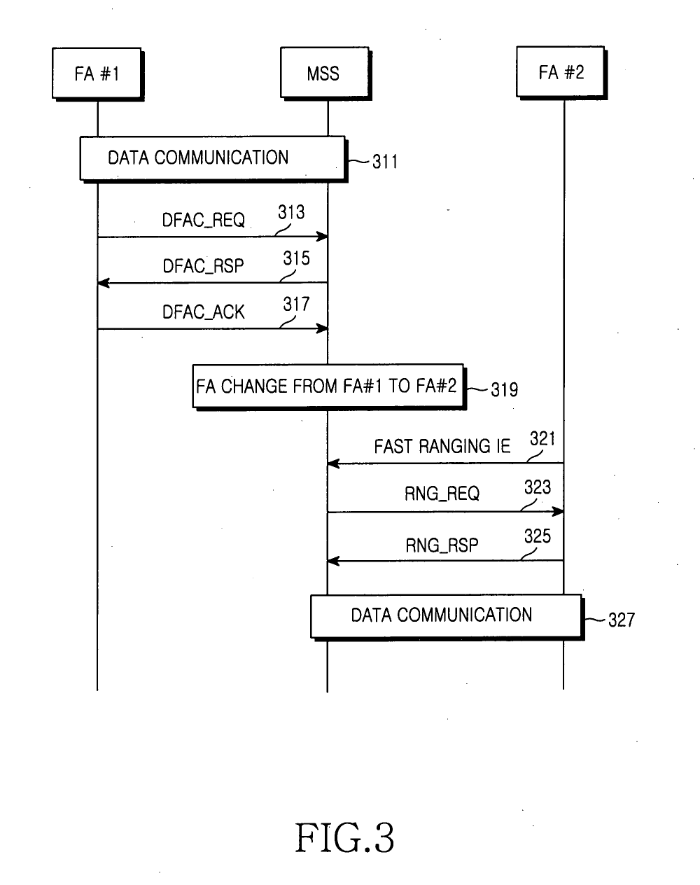

With reference to FIG. 3, a description will now be made of a process of changing an FA in an IEEE 802.16e communication system according to an embodiment of the present invention.

FIG. 3 is a signaling diagram illustrating a process of changing an FA in an IEEE 802.16e communication system according to an embodiment of the present invention. It will be assumed in FIG. 3 that a BS of the IEEE 802.16e communication system provides 2 FAs of FA#1 and FA#2, and an MSS is communicating with the BS through FA#1.

Referring to FIG. 3, while performing data communication with the MSS through FA#1 (Step 311), the BS can change an FA of the MSS from FA#1 to an FA different from FA#1, i.e., FA#2, for load sharing the load of FA#1. The BS transmits a Dynamic FA Change Request (DFAC_REQ) message to the MSS in order to change an FA of the MSS from FA#1 to FA#2 (Step 313). A format of the DFAC_REQ message is illustrated in Table 1.

TABLE 1

| Syntax | Size |
|---|---|
| DFAC-REQ_Message_Format( ) { | |
| Message Type | 8 bits |
| Transaction ID | 16 bits |
| FA ID | 8 bits |
| Initialization mode | 8 bits |
| TLV_DCD Substitution | variable |
| TLV_UCD Substitution | variable |
| TLV_B/P/S CID Substitution | 112 bits |
| TLV_SAID Substitution | variable |
| TLV_Service Flow Substitution | variable |
| TLV_HMAC Tuple | 168 bits |
| } | |

In Table 1, the DFAC_REQ message includes a plurality of Information Elements (IEs), i.e., a Message Type IE indicting a type of a transmission message, a Transaction ID IE indicating a transaction ID of a current transmission message, an FA ID IE indicating a target FA to which the MSS will change its FA, and an Initialization mode IE, in which an initialization mode value is written, indicting operations that the MSS should perform after changing its FA to the target FA. In the Initialization mode IE are written a total of 4 initialization mode values, i.e., initialization mode values for a mode 0 to a mode 3. A description will now be made of the 4 initialization modes.

First, a mode 0 represents a mode in which a value of the initialization mode IE is denoted by 0x00, and in this mode, the MSS should initialize a Medium Access Control (MAC) layer after changing its FA to the target FA. Here, that the MSS should initialize a MAC layer means that the MSS should perform a network re-entry operation with the BS through the target FA after changing its FA to the target FA.

Second, a mode 1 represents a mode in which a value of the initialization mode IE is denoted by 0x01, and in this mode, the MSS is not required to perform a network re-entry operation with the BS through the target FA after performing a contention-based initial ranging through the target FA after changing its FA to the target FA.

Third, a mode 2 represents a mode in which a value of the initialization mode IE is denoted by 0x10, and in this mode, the MSS is not required to perform a network re-entry operation with the BS through the target FA after performing a contention-free-based initial ranging through the target FA after changing its FA to the target FA.

Fourth, a mode 3 represents a mode in which a value of the initialization mode IE is denoted by 0x11, and in this mode, the MSS can directly communicate without the need to perform initial ranging after changing its FA to the target FA.

In Table 1, the other IEs of the DFAC_REQ message are coded in a TLV (Type/Length/Variable) form, and a Downlink Channel Descriptor (DCD) Substitution IE includes a downlink parameter list defined in the target FA, while an Uplink Channel Descriptor (UCD) Substitution IE includes an uplink parameter list defined in the target FA. The MSS can perform fast synchronization acquisition with the BS through the target FA using downlink parameters and uplink parameters written in the DCD Substitution IE and the UCD Substitution IE, and may write only the different parameters between the old FA and the target FA for efficient coding.

In addition, Basic/Primary/Secondary (B/P/S) Connection Identifier (CID) Substitution IEs include a Basic CID, a Primary CID and a Secondary CID that the MSS will use together with the BS through the target FA. If a value 0x00 indicating the mode 0 is written in the Initialization mode IE, the Basic/Primary/Secondary CID IEs may be omitted. A Security Association ID (SAID) Substitution IE includes a SAID with which the MSS will replace its SAID used together with the BS through the old FA and use the SAID through the target FA, and is coded in a form of an old SAID and a new SAID. A Service Flow Substitution IE includes a Service Flow ID (SFID) and a Transport CID with which the MSS will replace an SFID and a Transport CID together with the BS through the target FA, for all service flows used together with the BS through the old FA. An HMAC Tuple IE includes information for user authentication.

The MSS receiving the DFAC_REQ message from the BS through FA#1 recognizes that it should change its FA from FA#1 to FA#2, and transmits a Dynamic FA Change Response (DFAC_RSP) message to the BS in response to the DFAC_REQ message (Step 315). A format of the DFAC_RSP message is illustrated in Table 2.

TABLE 2

| Syntax | Size |
|---|---|
| DFAC-RSP_Message_Format( ) { | |
| Message Type | 8 bits |
| Transaction ID | 8 bits |
| Confirmation Code | 8 bits |
| Start time of transition | 8 bits |
| Length of transition | 8 bits |
| HMAC Tuple | 168 bits |
| } | |

In Table 2, the DFAC_RSP message includes a plurality of IEs, i.e., a Message Type IE indicting a type of a transmission message, a Transaction ID IE indicating a transaction ID of a current transmission message, a Confirmation code IE indicating an FA denial cause given when the MSS denies a change in FA, a Start time of transition IE indicating a time at which the MSS starts changing its FA to a target FA, a Length of transition IE indicating a time for which the MSS cannot exchange data with the BS beginning at a time written in the Start time of transition IE, and an HMAC Tuple IE including information for user authentication. A transaction ID written in the Transaction ID IE of the DFAC_RSP message is identical to a transaction ID written in the Transaction ID IE of the DFAC_REQ message, and because a detailed cause of denying the FA change by the MSS is not directly related to the present invention, it will not be described herein.

The BS receiving the DFAC_RSP message from the MSS transmits a Dynamic FA Change ACK (DFAC_ACK) message to the MSS in response to the DFAC_RSP message (Step 317). A format of the DFAC_ACK message is illustrated in Table 3.

TABLE 3

| Syntax | Size |
|---|---|
| DFAC-ACK_Message_Format( ) { | |
| Message Type | 8 bits |
| Transaction ID | 8 bits |
| HMAC Tuple | 168 bits |
| } | |

In Table 3, the DFAC_ACK message includes a plurality of IEs, i.e., a Message Type IE indicting a type of a transmission message, a Transaction ID IE indicating a transaction ID of a current transmission message, and an HMAC Tuple IE including information for user authentication. Here, a transaction ID written in the Transaction ID IE of the DFAC_ACK message is identical to a transaction ID written in the Transaction ID IE of the DFAC_RSP message.

The MSS receiving the DFAC_ACK message from the BS changes its FA from FA#1 to FA#2 (Step 319). As the MSS changes its FA from FA#1 to FA#2, the BS assigns a Fast Ranging IE to the MSS in order to support contention-free-based initial ranging, i.e., to support fast ranging, to the MSS through FA#2 (Step 321). The BS includes a Fast Ranging IE assigned for fast ranging of the MSS in a UL_MAP message broadcasted through FA#2, and accordingly, the MSS can recognize the Fast Ranging IE included in the UL_MAP message broadcasted from the BS through FA#2.

Based on the Fast Ranging IE, the MSS transmits a Ranging Request (RNG_REQ) message to the BS through FA#2 (Step 323). The BS receiving the RNG_REQ message from the MSS transmits a Ranging Response (RNG_RSP) message to the MSS through FA#2 in response to the RNG_REQ message (Step 325). The MSS receiving the RNG_RSP message from the BS performs data communication with the BS through FA#2 (Step 327).

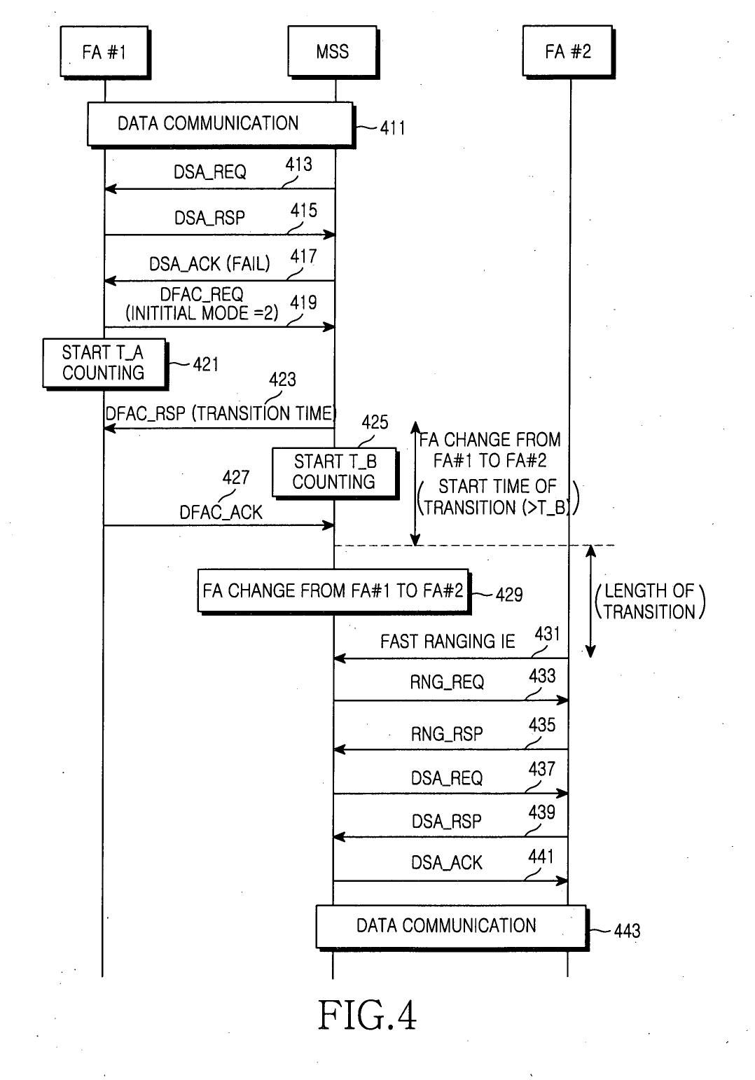

FIG. 4 is a signaling diagram illustrating a process of changing a service using an FA change scheme in an IEEE 802.16e communication system according to an embodiment of the present invention. It will be assumed in FIG. 4 that a BS of the IEEE 802.16e communication system provides 2 FAs of FA#1 and FA#2, and an MSS is performing data communication with the BS through FA#1.

Referring to FIG. 4, while communicating with the MSS through FA#1 (Step 411), the BS can request a service change. Here, an occasion on which the MSS requests a service change includes both an occasion on which the MSS requests a change in the service itself and an occasion on which the MSS requests addition of a service. When requesting a change in the service itself, the MSS transmits a Dynamic Service Change Request (DSC_REQ) message to the BS, and when requesting addition of a service, the MSS transmits a Dynamic Service Addition Request (DSA_REQ) message to the BS.

It will be assumed in FIG. 4 that the MSS requests a service change due to an addition of a service. The MSS transmits a DSA_REQ message to the BS in order to request the service addition (Step 413). The BS receiving the DSA_REQ message from the MSS determines if it can accept the service addition request of the MSS, and then transmits a Dynamic Service Addition Response (DSA_RSP) message including the determination result to the MSS in response to the DSA_REQ message (Step 415). It will be assumed in FIG. 4 that the BS is unable to add a service requested by the MSS through FA#1, and the BS transmits a DSA_RSP message including information indicating its inability to add the service. In addition, when the MSS transmits the DSC_REQ message, the BS transmits a Dynamic Service Change Response (DSC_RSP) message in response to the DSC_REQ message to inform the MSS whether or not it can change in the service itself.

The MSS receiving the DSA_RSP message recognizes that the BS cannot accept the service addition request through FA#1, and transmits a Dynamic Service Addition ACK (DSA_ACK) message to the BS through FA#1 (Step 417). The DSA_ACK message includes a Fail information indicating withdrawal of the service addition request. Then the BS determines if there is another FA capable of providing the service, an addition request which was made by the MSS. If it is determined that there is another FA capable of providing the service, an addition request which was made by the MSS, the BS transmits a DFAC_REQ message to the MSS through FA#1 (Step 419). It will be assumed in FIG. 4 that the BS can provide the service, an addition request which was made by the MSS, through FA#2. The DFAC_REQ message has an Initialization mode IE in which 0x10 indicating a mode 2 is written. Thus, upon receiving the DFAC_REQ message, the MSS will perform contention-free-based initial ranging with the BS through FA#2.

The BS starts counting a preset time T_A after transmitting the DFAC_REQ message (Step 421). Here, the preset time T_A represents a time for which the BS waits to retransmit the DFAC_REQ message. If the BS fails to receive a DFAC_RSP message from the MSS in response to the DFAC_REQ message until completed counting of the preset time T_A, the BS retransmits the DFAC_REQ message to the MSS.

Upon receiving the DFAC_REQ message from the BS, the MSS transmits a DFAC_RSP message to the BS in response to the DFAC_REQ message through FA#1 (Step 423). Here, the MSS determines if FA ID of a target FA included in the DFAC_REQ message is identical to an FA ID of the current FA through which the MSS is communicating. If it is determined that an FA ID of the target FA is not identical to an FA ID of the current FA through which the MSS is communicating, the MSS determines a start-time-of-transition indicating a time at which the MSS will start changing its FA to the target FA and a length-of-transition indicating a time for which the MSS cannot exchange data with the BS beginning at a time corresponding to the start-time-of-transition, taking into consideration the time required when the MSS changes its FA from the current FA to the target FA, and then transmits the DFAC_RSP message including the information identifying the determined start-time-of-transition and length-of-transition.

After transmitting the DFAC_RSP message to the BS, the MSS starts counting a preset time T_B (Step 425). The preset time T_B represents a time which the MSS waits to retransmit the DFAC_RSP message. If the MSS fails to receive a DFAC_ACK message from the BS in response to the DFAC_RSP message until completed counting of the preset time T_B, the MSS retransmits the DFAC_RSP message to the BS. It is preferable that the preset time T_B is set to a value less than the start-time-of-transition included in the DFAC_RSP message.

Upon receiving the DFAC_RSP message from the MSS, the BS transmits a DFAC_ACK message to the MSS through FA#1 in response to the DFAC_RSP message (Step 427). Upon receiving the DFAC_ACK message from the BS, the MSS changes its FA from FA#1 to FA#2 (Step 429). The BS assigns a Fast Ranging IE to the MSS in order to allow the MSS to perform contention-free-based initial ranging, i.e., to support fast ranging (Step 431). Here, the BS includes a Fast Ranging IE assigned for fast ranging of the MSS in a UL_MAP message broadcasted through FA#2, and accordingly, the MSS can recognize the Fast Ranging IE included in the UL_MAP message broadcasted from the BS through FA#2.

Based on the Fast Ranging IE, the MSS transmits a RNG_REQ message to the BS through FA#2 (Step 433). The BS receiving the RNG_REQ message from the MSS transmits a RNG_RSP message to the MSS through FA#2 in response to the RNG_REQ message (Step 435). The MSS receiving the RNG_RSP message from the BS transmits a DSA_REQ message to the BS through FA#2 to make a service addition request (Step 437). Upon receiving the DSA_REQ message from the MSS, the BS transmits a DSA_RSP message to the MSS through FA#2 in response to the DSA_REQ message (Step 439).

Upon receiving the DSA_RSP message from the BS, the MSS transmits a DSA_ACK message to the BS through FA#2 in response to the DSA_RSP message, determining that its service addition request is accepted by the BS (Step 441). After transmitting the DSA_ACK message to the BS, the MSS communicates on the added service with the BS through FA#2 (Step 443).

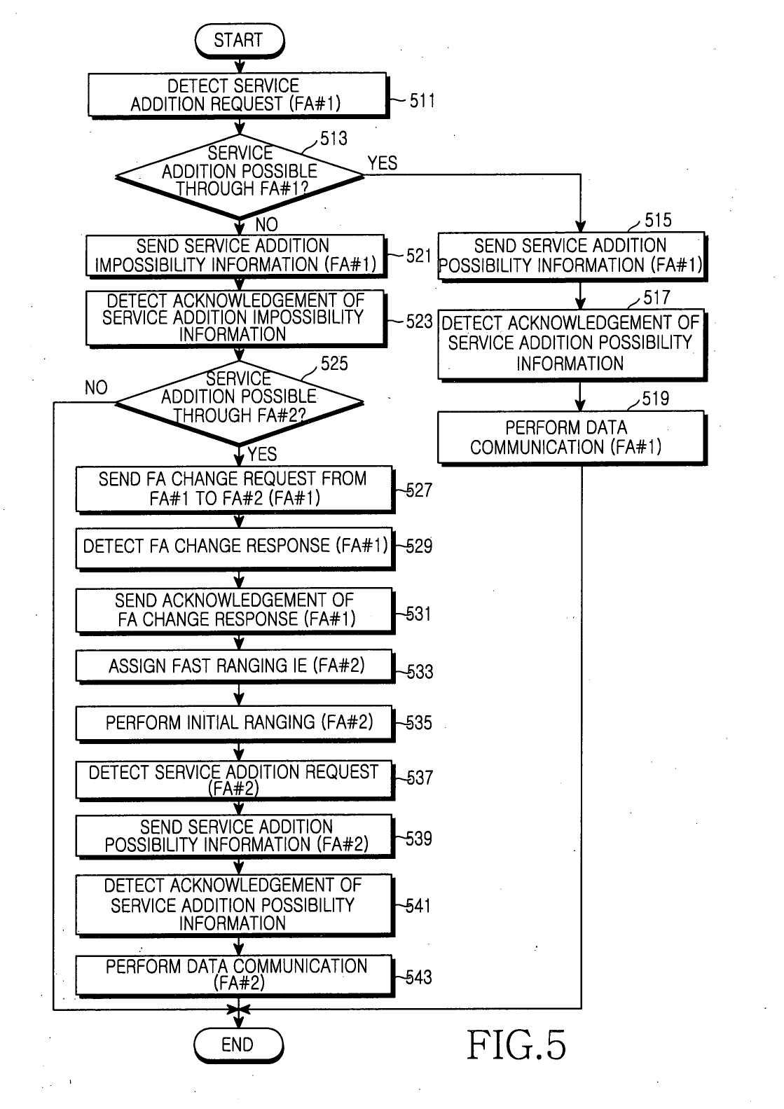

FIG. 5 is a flowchart illustrating a BS operation of changing a service using an FA change scheme in an IEEE 802.16e communication system according to an embodiment of the present invention.

Before a description of FIG. 5 is given, it will be assumed that although an MSS can request a service change by either requesting a change in the service itself or requesting addition of a service, the MSS requests a service change by requesting addition of a service in FIG. 5.

Referring to FIG. 5, if the BS detects a service addition request from an MSS through FA#1, i.e., receives a DSA_REQ message from the MSS in step 511, it proceeds to step 513. In step 513, the BS determines if it can add the service requested by the MSS through FA#1.

If it is determined that the BS can add the service requested by the MSS through FA#1, the BS proceeds to step 515. In step 515, the BS informs the MSS of its possibility of the service addition through FA#1, i.e., transmits a DSA_RSP message including whether or not it can add of the service to the MSS in response to the DSA_REQ message, and then proceeds to step 517. In step 517, the BS detects through FA#1 that the MSS has acknowledged the service addition possibility information, i.e., receives a DSA_ACK message including the Success information indicating an intention to implement the service addition from the MSS through FA#1, and then proceeds to step 519. In step 519, the BS communicates with the MSS through FA#1, and then ends its operation.

However, if it is determined in step 513 that it is not possible to add the service requested by the MSS through FA#1, the BS proceeds to step 521. In step 521, the BS informs the MSS of its inability to add the service through FA#1, i.e., transmits a DSA_RSP message including information indicating the inability to add the service to the MSS in response to the DSA_REQ message, and then proceeds to step 523. In step 523, the BS detects through FA#1 that the MSS has acknowledged the service addition impossibility information, i.e., receives a DSA_ACK message including the Fail information indicating an intention to withdrawal the service addition request from the MSS through FA#1, and then proceeds to step 525. In step 525, the BS determines if it is possible to add the service through an FA different from FA#1, i.e., FA#2.

If it is determined that it is possible to add the service requested by the MSS through FA#2, the BS proceeds to step 527. In step 527, because it is possible for the BS to add the service through FA#2, the BS requests the MSS to change its FA from FA#1 to FA#2, i.e., transmits a DFAC_REQ message to the MSS, and then proceeds to step 529. In step 529, the BS detects the FA change information from the MSS through FA#1, i.e., receives a DFAC_RSP message from the MSS in response to the DFAC_REQ message, and then proceeds to step 531. In step 531, the BS informs the MSS of an acknowledgement of the FA change information through FA#1, i.e., transmits a DFAC_ACK message to the MSS, and then proceeds to step 533.

In step 533, as the MSS changes its FA from FA#1 to FA#2, the BS assigns a Fast Ranging IE to the MSS through FA#2, and then proceeds to step 535. In step 535, the BS performs initial ranging with the MSS through FA#2, and then proceeds to step 537. In step 537, if a service addition request is received from the MSS through FA#2, i.e., if a DSA_REQ message is received from the MSS, the BS proceeds to step 539. In step 539, because it is possible for the BS to add the service through the FA#2, the BS informs the MSS of its ability to add the service through FA#2, i.e., transmits a DSA_RSP message including information indicating the ability to add the service to the MSS in response to the DSA_REQ message, and then proceeds to step 541. In step 541, the BS detects through FA#2 that the MSS has acknowledged the service addition impossibility information, i.e., receives a DSA_ACK message including the Success information indicating an intention to implement the service addition from the MSS through FA#2, and then proceeds to step 543. In step 543, the BS communicates with the MSS through FA#2, and then ends its operation.

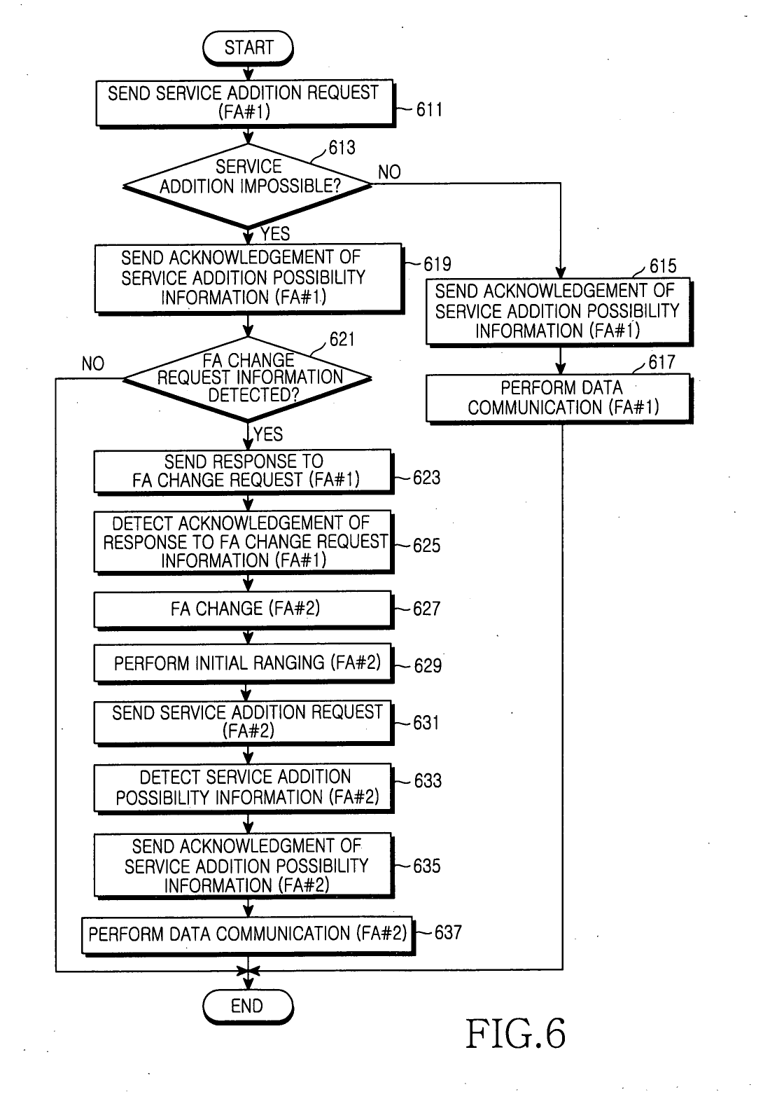

FIG. 6 is a flowchart illustrating an MSS operation of changing a service using an FA change scheme in an IEEE 802.16e communication system according to an embodiment of the present invention.

Before a description of FIG. 6 is given, it will be assumed that although the MSS can request a service change by either requesting a change in the service itself or requesting addition of a service, the MSS requests a service change by requesting addition of a service in FIG. 6.

Referring to FIG. 6, when the MSS desires to add a service, it requests the BS for service addition through FA#1, i.e., transmits a DSA_REQ message to the BS in step 611, and then proceeds to step 613. In step 613, the MSS determines if it is informed of service addition impossibility from the BS through FA#1 in response to the service addition request, i.e., a DSA_RSP message indicating the inability to add a service is received from the BS through FA#1. If it is determined that the MSS is not informed of the service addition impossibility from the BS, i.e., a DSA-RSP message indicating possibility of adding a service is received from the BS through FA#1, the MSS proceeds to step 615. In step 615, the MSS informs the BS through FA#1 that it has acknowledged the service addition possibility information, i.e., transmits a DSA_ACK message to the BS, and then proceeds to step 617. In step 617, the MSS performs data communication with the BS through FA#1, and then ends its operation.

However, if it is determined in step 613 that the MSS is informed of the service addition impossibility from the BS, i.e., a DSA_RSP message indicating an inability to add a service is received from the BS through FA#1, the MSS proceeds to step 619. In step 619, the MSS informs the BS of acknowledgement of the service addition impossibility information, i.e., transmits a DSA_ACK message to the BS, and then proceeds to step 621. In step 621, the MSS determines if FA change request information is detected from the BS through FA#1, i.e., a DFAC_REQ message is received from the BS.

If it is determined that FA change request information is not detected from the BS, the MSS proceeds to step 623. In step 623, the MSS transmits a response to the FA change request information to the BS through FA#1, i.e., transmits a DFAC_RSP message to the BS in response to the DFAC_REQ message, and then proceeds to step 625. In step 625, the MSS detects acknowledgement of the FA change request information from the BS through FA#1, i.e., receives a DFAC_ACK message from the BS, and then proceeds to step 627. In step 627, the MSS changes its FA from FA#1 to FA#2, and then proceeds to step 629.

In step 629, the MSS performs an initial ranging operation using a Fast Ranging IE assigned by the BS through FA#2, and then proceeds to step 631. In step 631, the MSS sends a service addition request to the BS through FA#2, i.e., transmits a DSA_REQ message to the BS, and then proceeds to step 633. In step 633, the MSS detects service addition possibility information from the BS through FA#2 in response to the service addition request, i.e., receives a DSA_RSP message from the BS, and then proceeds to step 635. In step 635, the MSS informs the BS of acknowledgement of the service addition possibility information through FA#2, i.e., transmits a DSA_ACK message to the BS, and then proceeds to step 637. In step 637, the MSS communicates with the BS through FA#2, and then ends its operation.

As described above, the present invention dynamically changes an FA in a Broadband Wireless Access (BWA) communication system, particularly, in a BWA communication system providing a plurality of FAs, thereby minimizing a service delay and the number of exchanged messages, thus contributing to an increase in the quality-of-service (QoS).

While the invention has been shown and described with reference to a certain preferred embodiment thereof, it will be understood by those skilled in the art that various changes in form and details may be made therein without departing from the spirit and scope of the invention as defined by the appended claims.

1. A method for changing a Frequency Assignment (FA) to allow a subscriber station (SS) communicating with a base station (BS) through a first FA to communicate with the BS through a second FA, in a Broadband Wireless Access (BWA) communication system having at least two FAs, the method comprising the steps of:
requesting, by a BS, a SS to change its FA from a first FA to a second FA, upon detecting a need to change an FA of the SS from the first FA to the second FA while communicating with the SS;
informing, by the SS, the BS that it will change its FA from the first FA to the second FA in response to the FA change request, and then changing its FA from the first FA to the second FA; and
after changing the FA, communicating by the SS with the BS through the second FA.

2. The method of claim 1, wherein the step of communicating by the SS with the BS, comprises the step of communicating by the SS with the BS through the second FA using connection information acquired from the BS while communicating at the first FA.

3. The method of claim 1, wherein the step of communicating by the SS with the BS, comprises the steps of:
after changing the FA, receiving an assigned fast ranging resource from the BS through the second FA so that the SS can perform contention-free-based initial ranging;
performing contention-free-based initial ranging with the BS through the second FA according to the assigned fast ranging resource; and
after performing the contention-free-based initial ranging, communicating with the BS through the second FA.

4. The method of claim 1, wherein the step of communicating, by the SS with the BS comprises the steps of:
after changing the FA, receiving an assigned ranging resource from the BS through the second FA so that the SS can perform initial ranging;
performing initial ranging with the BS through the second FA according to the assigned ranging resource; and
after performing the initial ranging, communicating with the BS through the second FA.

5. The method of claim 1, wherein the step of communicating, by the SS with the BS comprises the steps of:
after changing the FA, performing a network re-entry operation with the BS through the second FA;
after performing the network re-entry operation, receiving an assigned ranging resource from the BS through the second FA so that the SS can perform initial ranging;
performing initial ranging with the BS through the second FA according to the assigned ranging resource; and
after performing the initial ranging, communicating with the BS through the second FA.

6. The method of claim 1, wherein the step of informing, by the SS, the BS that it will change its FA from the first FA to the second FA comprises the step of providing the BS with FA change information including information identifying a start time of a transition, at which the SS will start changing its FA from the first FA to the second FA, and a time for which the SS cannot exchange data with the BS due to the change in FA beginning at the start time of transition.

7. The method of claim 1, wherein the BS performs FA change request from the first FA to the second FA by transmitting a dynamic FA change request (DFAC_REQ) message to the SS.

8. The method of claim 7, wherein the DFAC_REQ message includes a transaction identifier (ID) field indicating a transaction ID of a current transmission message, a target FA ID field indicating a target FA to which the SS will change its FA, an initialization mode field indicating an operation that the SS will perform after changing its FA to the target FA, and a plurality of Type/Length/Variable (TLV) fields.

9. The method of claim 8, wherein the plurality of TLV fields denote a downlink channel descriptor (DCD) substitution field, a uplink channel descriptor (UCD) substitution field, a Basic/Primary/Secondary (B/P/S) field, a security association ID (SAID) substitution field, a service flow ID field, and a user authentication information field.

10. The method of claim 1, wherein the SS informs the BS that it will change its FA from the first FA to the second FA, by transmitting to the BS a dynamic FA change response (DFAC_RSP) message.

11. The method of claim 10, wherein the DFAC_RSP message includes a transaction ID field indicating a transaction ID of a current transmission message, a confirmation code field indicting an FA denial cause given when the SS denies a change in the FA, a start-time-of-transition field indicating a time at which the SS starts changing its FA, and a length-of-transition field indicating a time for which the SS cannot exchange data with the BS beginning at a time written in the start-time-of-transition field.

12. The method of claim 10, wherein upon receiving the DFAC_RSP message, the BS transmits to the SS a dynamic FA change acknowledgement (DFAC_ACK) message acknowledging receipt of the DFAC_RSP message.

13. The method of claim 12, wherein the DFAC_ACK message includes a transaction ID field indicating a transaction ID of a current transmission message.

14. A method for changing a service through a second Frequency Assignment (FA) by a subscriber station (SS) in communication with a base station (BS) through a first FA, in a Broadband Wireless Access (BWA) communication system having at least two FAs, the method comprising the steps of:
requesting, by the SS, the BS to change the service, upon detecting a need to change the service while in communication with the BS through the first FA;
upon detecting the service change request, determining by the BS if it can change the service through the first FA;
if it is determined that it is not possible to change the service, requesting, by the BS, the SS to change its FA from the first FA to the second FA;
informing, by the SS, the BS that it will change its FA from the first FA to the second FA in response to the FA change request, and then changing its FA from the first FA to the second FA; and
after changing the FA, performing, by the SS, service change with the BS through the second FA.

15. The method of claim 14, wherein the step of performing, by the SS, the service change with the BS, comprises the steps of:
requesting the BS to change the service through the second FA using connection information acquired from the BS while communicating at the first FA; and
performing the changed service with the BS upon receiving service change possibility information from the BS in response to the service change request.

16. The method of claim 14, wherein the step of performing, by the SS, service change with the BS, comprises the steps of:
after changing the FA, receiving an assigned fast ranging resource from the BS through the second FA so that the SS can perform contention-free-based initial ranging;
performing contention-free-based initial ranging with the BS through the second FA according to the assigned fast ranging resource;
after performing the contention-free-based initial ranging, requesting through the second FA the BS to change the service; and
performing the changed service with the BS upon receiving service change possibility information from the BS in response to the service change request.

17. The method of claim 14, wherein the step of performing, by the SS, service change with the BS, comprises the steps of:
after changing the FA, receiving an assigned ranging resource from the BS through the second FA so that the SS can perform initial ranging;
performing initial ranging with the BS through the second FA according to the assigned ranging resource;
after performing the initial ranging, requesting the BS to change the service through the second FA; and
performing the changed service with the BS upon receiving service change possibility information from the BS in response to the service change request.

18. The method of claim 14, wherein the step of performing, by the SS, service change with the BS, comprises the steps of:
after changing the FA, performing a network re-entry operation with the BS through the second FA;
after performing the network re-entry operation, receiving an assigned ranging resource from the BS through the second FA so that the SS can perform initial ranging;
performing initial ranging with the BS through the second FA according to the assigned ranging resource;
after performing the initial ranging, requesting through the second FA the BS to change the service; and
performing the changed service with the BS upon receiving service change possibility information from the BS in response to the service change request.

19. The method of claim 14, wherein the step of informing, by the SS, the BS that it will change its FA from the first FA to the second FA, comprises the step of providing the BS with FA change information including information on a start time of transition, at which time the SS will start changing its FA from the first FA to the second FA, and a time for which the SS cannot exchange data with the BS due to the change in the FA beginning at the start time of transition.

20. A system for changing a Frequency Assignment (FA) to allow a subscriber station (SS) communicating with a base station (BS) through a first FA to communicate with the BS through a second FA, in a Broadband Wireless Access (BWA) communication system having at least two FAs, the system comprising:
a BS for requesting a SS to change its FA from a first FA to a second FA upon detecting a need to change an FA of the SS from the first FA to the second FA while communicating with the SS, and communicating with the SS through the second FA upon the receipt of information indicating that the SS will change its FA from the first FA to the second FA, from the SS in response to the FA change request; and
the SS for informing the BS that it will change its FA from the first FA to the second FA in response to the FA change request, changing its FA from the first FA to the second FA, and communicating with the BS through the second FA.

21. The system of claim 20, wherein the SS communicates with the BS through the second FA using connection information acquired from the BS while communicating at the first FA.

22. The system of claim 20, wherein the SS, after changing the FA, receives an assigned fast ranging resource from the BS through the second FA so that the SS can perform contention-free-based initial ranging; performs contention-free-based initial ranging with the BS through the second FA according to the assigned fast ranging resource; and after performing the contention-free-based initial ranging, communicates with the BS through the second FA.

23. The system of claim 20, wherein the SS, after changing the FA, receives an assigned ranging resource from the BS through the second FA so that the SS can perform initial ranging; performs initial ranging with the BS through the second FA according to the assigned ranging resource; and after performing the initial ranging, communicates with the BS through the second FA.

24. The system of claim 20, wherein the SS, after changing the FA, performs a network re-entry operation with the BS through the second FA; after performing the network re-entry operation, receives an assigned ranging resource from the BS through the second FA so that the SS can perform initial ranging; performs initial ranging with the BS through the second FA according to the assigned ranging resource; and after performing the initial ranging, communicates with the BS through the second FA.

25. The system of claim 20, wherein the SS provides the BS with FA change information including information indicating a start time of transition, at which the SS will start changing its FA from the first FA to the second FA, and a time for which the SS cannot exchange data with the BS due to the change in FA beginning at the start time of transition.

26. The system of claim 20, wherein the BS performs FA change request from the first FA to the second FA by transmitting a dynamic FA change request (DFAC_REQ) message to the SS.

27. The system of claim 26, wherein the DFAC_REQ message includes a transaction identifier (ID) field indicating a transaction ID of a current transmission message, a target FA ID field indicating a target FA to which the SS will change its FA, an initialization mode field indicating an operation that the SS will perform after changing its FA to the target FA, and a plurality of Type/Length/Variable (TLV) fields.

28. The system of claim 27, wherein the plurality of TLV fields denote a downlink channel descriptor (DCD) substitution field, a uplink channel descriptor (UCD) substitution field, a Basic/Primary/Secondary (B/P/S) field, a security association ID (SAID) substitution field, a service flow ID field, and a user authentication information field.

29. The system of claim 20, wherein the SS informs the BS that it will change its FA from the first FA to the second FA, by transmitting to the BS a dynamic FA change response (DFAC_RSP) message.

30. The system of claim 29, wherein the DFAC_RSP message includes a transaction ID field indicating a transaction ID of a current transmission message, a confirmation code field indicting an FA denial cause given when the SS denies a change in the FA, a start-time-of-transition field indicating a time at which the SS starts changing its FA, and a length-of-transition field indicating a time for which the SS cannot exchange data with the BS beginning at a time written in the start-time-of-transition field.

31. The system of claim 29, wherein upon receiving the DFAC_RSP message, the BS transmits to the SS a dynamic FA change acknowledgement. (DFAC_ACK) message acknowledging receipt of the DFAC_RSP message.

32. The system of claim 31, wherein the DFAC_ACK message includes a transaction ID field indicating a transaction ID of a current transmission message.

33. A system for changing a service through a second Frequency Assignment (FA) by a subscriber station (SS) communicating with a base station (BS) through a first FA, in a Broadband Wireless Access (BWA) communication system having at least two FAs, the system comprising:
a SS for requesting a BS to change the service upon detecting a need to change the service while communicating with the BS through the first FA, informing the BS that it will change its FA from the first FA to the second FA in response to an FA change request and then changing its FA from the first FA to the second FA when it is requested by the BS to change its FA from the first FA to the second FA due to an inability by the BS to change the service, and then performing service change with the BS through the second FA; and
the BS for, upon detecting the service change request, determining if it can change the service through the first FA, if it is determined that it is not possible to change the service, requesting the SS to change its FA from the first FA to the second FA, and then, upon receiving, from the SS, information indicating that it will change its FA from the first FA to the second FA in response to the FA change request, performing service change with the SS through the second FA.

34. The system of claim 33, wherein the SS, requests the BS to change the service through the second FA using connection information acquired from the BS while communicating at the first FA; and performs the changed service with the BS upon receiving service change possibility information from the BS in response to the service change request.

35. The system of claim 33, wherein the SS, after changing the FA, receives an assigned fast ranging resource from the BS through the second FA so that the SS can perform contention-free-based initial ranging; performs contention-free-based initial ranging with the BS through the second FA according to the assigned fast ranging resource; after performing the contention-free-based initial ranging, requests the BS to change the service through the second FA; and performs the changed service with the BS upon receiving service change possibility information from the BS in response to the service change request.

36. The system of claim 33, wherein the SS, after changing the FA, receives an assigned ranging resource from the BS through the second FA so that the SS can perform initial ranging; performs initial ranging with the BS through the second FA according to the assigned ranging resource; after performing the initial ranging, requests the BS to change the service through the second FA; and performs the changed service with the BS upon receiving service change possibility information from the BS in response to the service change request.

37. The system of claim 33, wherein the SS, after changing the FA, performs a network re-entry operation with the BS through the second FA; after performing the network re-entry operation, receives an assigned ranging resource from the BS through the second FA so that the SS can perform initial ranging; performs initial ranging with the BS through the second FA according to the assigned ranging resource; after performing the initial ranging, requests the BS to change the service through the second FA; and performs the changed service with the BS upon receiving service change possibility information from the BS in response to the service change request.

38. The system of claim 33, wherein the SS provides the BS with FA change information including information indicating a start time of transition, at which the SS will start changing its FA from the first FA to the second FA, and a time for which the SS cannot exchange data with the BS due to the change in FA beginning at the start time of transition.

39. A method for communicating with a base station (BS) by a subscriber station (SS) when the SS communicating with the BS through a first Frequency Assignment (FA) changes its FA to a second FA, in a Broadband Wireless Access (BWA) communication system having at least two FAs, the method comprising the steps of:
after changing the FA, receiving an assigned fast ranging resource from the BS through the second FA so that the SS can perform contention-free-based initial ranging;
sending an initial ranging request to the BS through the second FA using the assigned fast ranging resource;
receiving a response to the initial ranging request from the BS; and
after receiving the response to the initial ranging request, communicating with the BS through the second FA.

40. A method for communicating with a base station (BS) by a subscriber station (SS) when the SS communicating with the BS through a first Frequency Assignment (FA) changes its FA to a second FA, in a Broadband Wireless Access (BWA) communication system having at least two FAs, the method comprising the steps of:
after changing the FA, receiving an assigned fast ranging resource from the BS through the second FA so that the SS can perform contention-free-based initial ranging;
sending an initial ranging request to the BS through the second FA using the assigned fast ranging resource;
receiving a response to the initial ranging request from the BS;
after receiving the response to the initial ranging request, sending a service change request to the BS through the second FA upon detecting necessity of changing a service;
upon receiving service change possibility information from the BS in response to the service change request, informing the BS of acknowledgement of the service change possibility information; and
performing the changed service with the BS.
